(19) United States
(12) Patent Application Publication
(10) Pub. No.: US 2024/0375571 A1
(43) Pub. Date: Nov. 14, 2024

(54) Vehicle with Side Dump and Rear Dump Beds

(71) Applicant: C5 Manufacturing, LLC, Kingman, KS (US)

(72) Inventors: Corey Cress, Colwich, KS (US); Mark Smith, Kingman, KS (US)

(21) Appl. No.: 18/658,642

(22) Filed: May 8, 2024

Related U.S. Application Data
(60) Provisional application No. 63/500,836, filed on May 8, 2023.

(51) Int. Cl. B60P 1/28; B60P 1/16; B60P 1/32

(52) U.S. Cl. CPC B60P 1/28; B60P 1/165; B60P 1/32

(57) ABSTRACT

A utility vehicle includes a wheeled chassis and a side-dump bed. The wheeled chassis includes a chassis frame extending along a fore-and-aft vehicle axis. The side-dump bed is configured to contain and selectively discharge material toward a dump side of the wheeled chassis. The side-dump bed is shiftably attached to the chassis frame for movement between a lowered condition, in which the side-dump bed extends laterally from the dump side of the wheeled chassis to the other side, and a raised condition, in which the side-dump bed is shifted toward the dump side to discharge material.

### CROSS-REFERENCE TO RELATED APPLICATIONS

This application claims the priority benefit of U.S. Provisional Application Ser. No. 63/500,836, filed May 8, 2023, entitled VEHICLE WITH SIDE DUMP AND REAR DUMP BEDS, which is hereby incorporated in its entirety by reference herein.

### BACKGROUND

### 1. Field

The present invention relates to vehicles used to hold and transport landscaping equipment and materials. Aspects of the present invention more particularly relate to a landscaping vehicle with a front dump box and a rear dump bed operable to hold materials and landscaping equipment.

### 2. Description of Related Art

Conventional utility trucks and trailers are customarily used for commercial outdoor work (such as landscaping work) and have a hydraulic bed that is operable to receive equipment and other materials. The bed may be raised and lowered via a hydraulic cylinder to facilitate loading and unloading of equipment or materials.

However, prior art vehicles used to haul landscaping materials have various deficiencies. For instance, prior art trucks and trailers with a dump box for collecting and transporting materials require significant manual effort to transfer materials into the dump box. Such conventional vehicles with dump boxes are also notoriously awkward to dump materials from the dump box. There is a need for an alternative to the standard vehicles that may enable more efficient collection and discharge of landscaping materials.

This background discussion is intended to provide information related to the present disclosure which is not necessarily prior art.

### SUMMARY

The following brief summary is provided to indicate the nature of the subject matter disclosed herein. While certain aspects of the present disclosure are described below, the summary is not intended to limit the scope of the present invention.

Embodiments of the present disclosure provide a vehicle that does not suffer from the problems and limitations of prior art vehicles, such as the vehicles set forth above.

An aspect of the present disclosure concerns a utility vehicle configured to be advanced forwardly during transport. The utility vehicle broadly includes a wheeled chassis and a side-dump bed. The wheeled chassis includes a chassis frame extending along a fore-and-aft vehicle axis. The side-dump bed is configured to contain and selectively discharge material toward a dump side of the wheeled chassis. The side-dump bed is shiftably attached to the chassis frame for movement between a lowered condition, in which the side-dump bed extends laterally from the dump side of the wheeled chassis to the other side, and a raised condition, in which the side-dump bed is shifted toward the dump side to discharge material.

Another aspect of the present disclosure concerns a utility vehicle configured to be advanced forwardly during transport. The utility vehicle broadly includes a wheeled chassis, a forward bed, and an aft bed. The wheeled chassis includes a chassis frame extending along a fore- and -aft vehicle axis. The forward bed and the aft bed are each supported by the wheeled chassis, with the aft bed located rearwardly of the forward bed. At least one of the forward bed and the aft bed comprises a side-dump bed configured to contain and selectively discharge material toward a dump side of the wheeled chassis. The side-dump bed is shiftably attached to the chassis frame for movement between a lowered condition, in which the side-dump bed extends laterally from the dump side of the wheeled chassis to the other side, and a raised condition, in which the side-dump bed is shifted toward the dump side to discharge material.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a left side elevation view of a utility vehicle constructed in accordance with a preferred embodiment of the present invention, with the utility vehicle including a wheeled chassis, a side-dump bed, and a rear-dump bed;

FIG. 2 is a right side elevation view of the utility vehicle shown in FIG. 1;

FIG. 3 is a rear perspective view of the utility vehicle shown in FIGS. 1 and 2, with the side-dump bed and rear-dump bed both being raised;

FIG. 4 is a front perspective view of the utility vehicle similar to FIG. 3, but taken from the opposite side of the utility vehicle;

FIG. 5 is a schematic rear view of the utility vehicle shown in FIGS. 1-4, showing an outrigger operably mounted to the wheeled chassis;

FIG. 6 is a schematic rear view of the utility vehicle similar to FIG. 5, but showing the side-dump bed being raised;

FIG. 7 is a schematic left side elevation view of the utility vehicle shown in FIGS. 1-6, showing raised and lowered positions of the rear-dump bed;

FIG. 8 is a fragmentary rear perspective of the utility vehicle shown in FIGS. 1-7, showing a door of the side-dump bed in a closed position;

FIG. 9 is a fragmentary rear perspective of the utility vehicle similar to FIG. 8, but showing the side-dump bed raised and the door of the side-dump bed in an open position;

FIG. 10 is a fragmentary rear perspective of a utility vehicle constructed in accordance with a second embodiment, with the side-dump bed including an alternative door, showing the side-dump bed raised and the alternative door opened; and

FIG. 11 is a fragmentary rear elevation of a utility vehicle constructed in accordance with a third embodiment, with the side-dump bed including a rear door that forms part of a dump box and permits access to the dump box from the rear-dump bed.

The drawing figures do not limit the present invention to the specific embodiments disclosed and described herein. While the drawings do not necessarily provide exact dimensions or tolerances for the illustrated components or structures, the drawings, not including any purely schematic drawings, are to scale with respect to the relationships between the components of the structures illustrated therein.

### DETAILED DESCRIPTION OF THE EXEMPLARY EMBODIMENTS

The following detailed description of embodiments of the invention references the accompanying figures. The embodiments are intended to describe aspects of the invention in sufficient detail to enable those with ordinary skill in the art to practice the invention. The embodiments of the disclosure are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

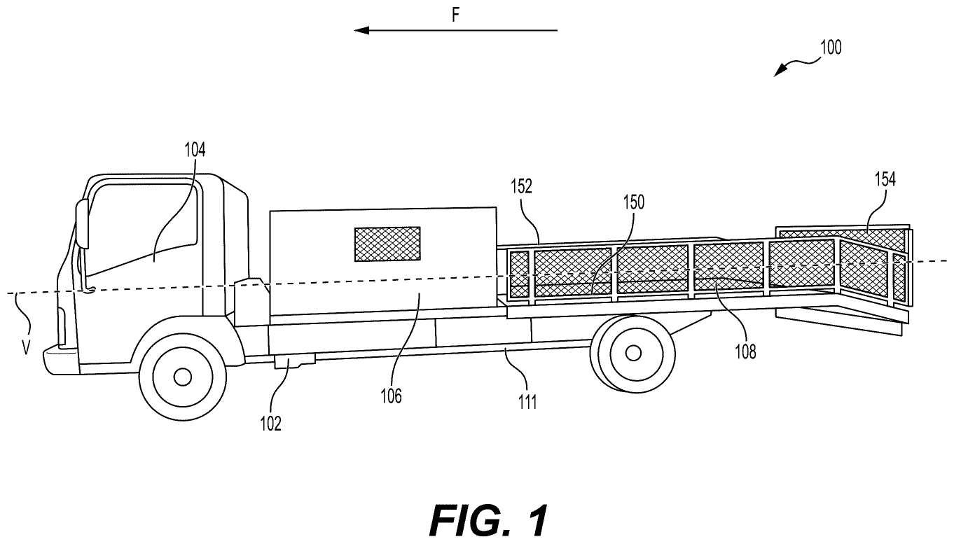

Turning initially to FIGS. 1-3, a utility vehicle 100 is operable to hold and transport materials and equipment. Utility vehicle 100 may be configured to be advanced forwardly (that is, in forward direction F) during transport. The utility vehicle 100 broadly includes a wheeled chassis 102, a cab 104, a motor (not shown), a side-dump bed 106, a rear-dump bed 108, and an outrigger 110.

The utility vehicle 100 may comprise a landscaping vehicle for use in transporting landscaping material (which may include waste material or new material for application or installation), other materials (such as construction materials like wood, stone, brick, concrete, etc.), tools, and/or landscaping equipment (such as mowers, trimmers, blowers, diggers, trenchers, saws, etc.). Landscaping material may include limbs, branches, leaves, grass clippings, mulch, flowers, plants, bushes, shrubs, rock, gravel, stone, brick, fabric, wood, sand, soil, fertilizer (in solid or liquid form), pesticide (in solid or liquid form), etc. However, embodiments of the utility vehicle may be utilized for other purposes. For example, it will be appreciated that vehicle embodiments may be used to haul equipment and materials for construction, agricultural, or other commercial purposes.

Wheeled chassis 102 may include a chassis frame 111. In the usual manner, chassis frame 111 may extend along a fore-and-aft vehicle axis V and may include a pair of side-by-side beams 111a and 111b. Beams 111a and 111b may extend alongside one another between forward and aft ends. Chassis frame 111 may be configured to operably support the cab 104 and beds 106 and 108.

The wheeled chassis 102, cab 104, and motor are preferably incorporated as part of a self-powered utility truck. It is also within the scope of at least certain aspects of the present invention to use an alternative self-powered vehicle, such as an agricultural truck or tractor. Yet further, alternative embodiments may comprise a vehicle that is not self-powered. For instance, at least some aspects of the invention may be incorporated as part of a wheeled trailer that may be towed behind a powered vehicle (such as a self-powered truck or tractor).

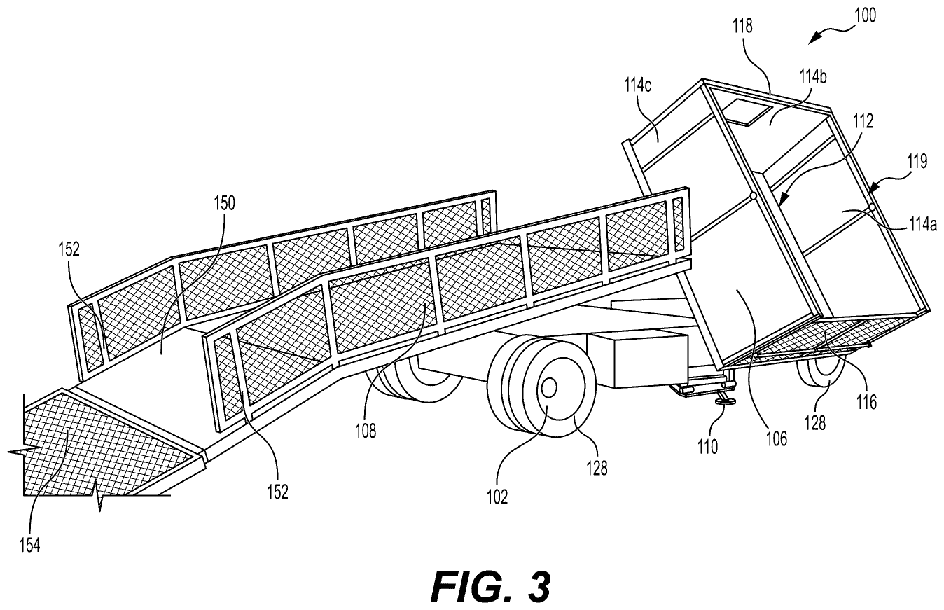

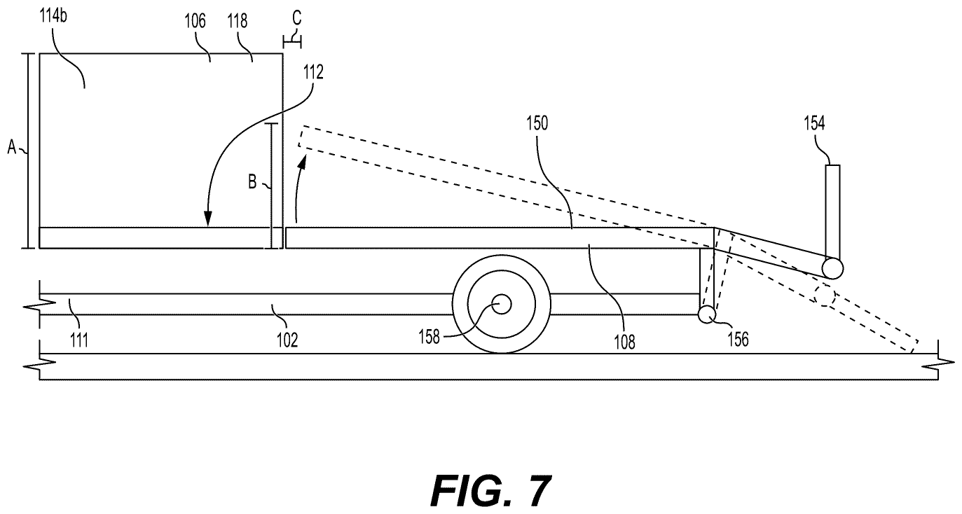

Turning to FIGS. 3-10, the side-dump bed 106 may preferably include a floor 112, side walls 114a, 114b, 114c, and an outboard door 116 that cooperatively form a dump box 118 with a chamber 119 (see FIG. 3). Side walls 114a, 114b, 114c define a dump box internal height dimension A (see FIG. 7) associated with an internal volume of the dump box. Preferably, the dump box internal height dimension ranges from about twelve inches (12″) to about sixty inches (60″) and, more preferably, ranges from about thirty-six inches (36″) to about forty-eight inches (48″). The dump box 118 may be configured to hold and transport various landscaping materials, such as grass clippings, leaves, branches, etc.

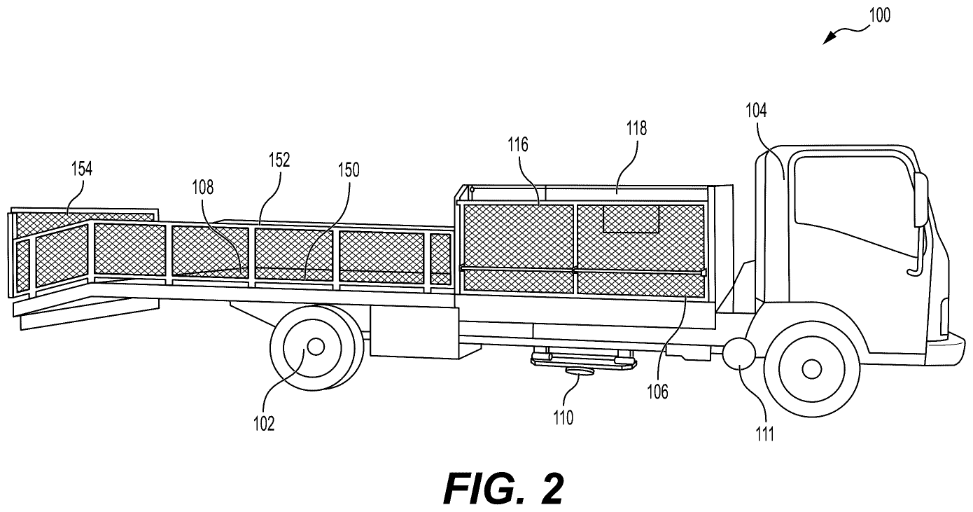

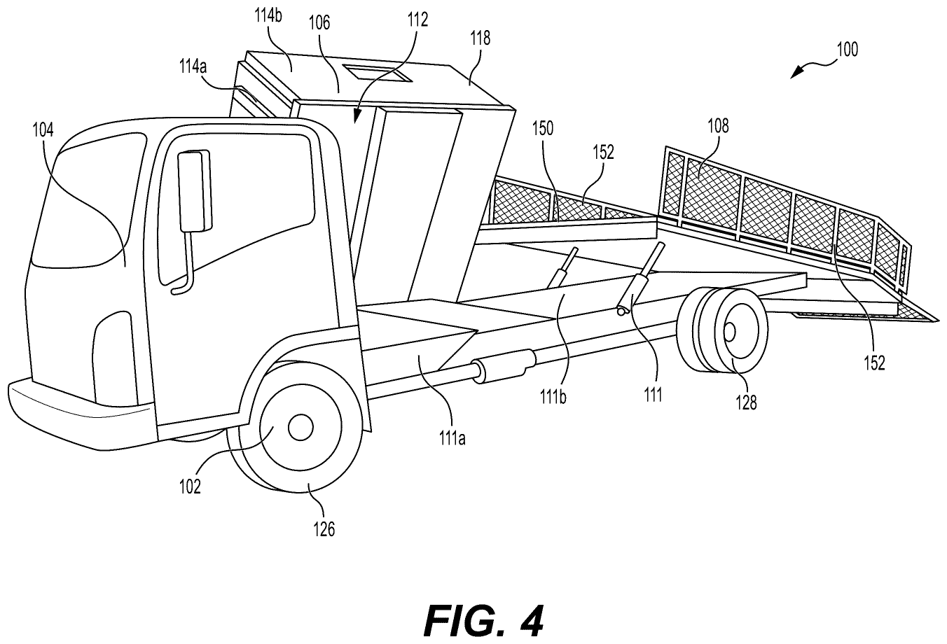

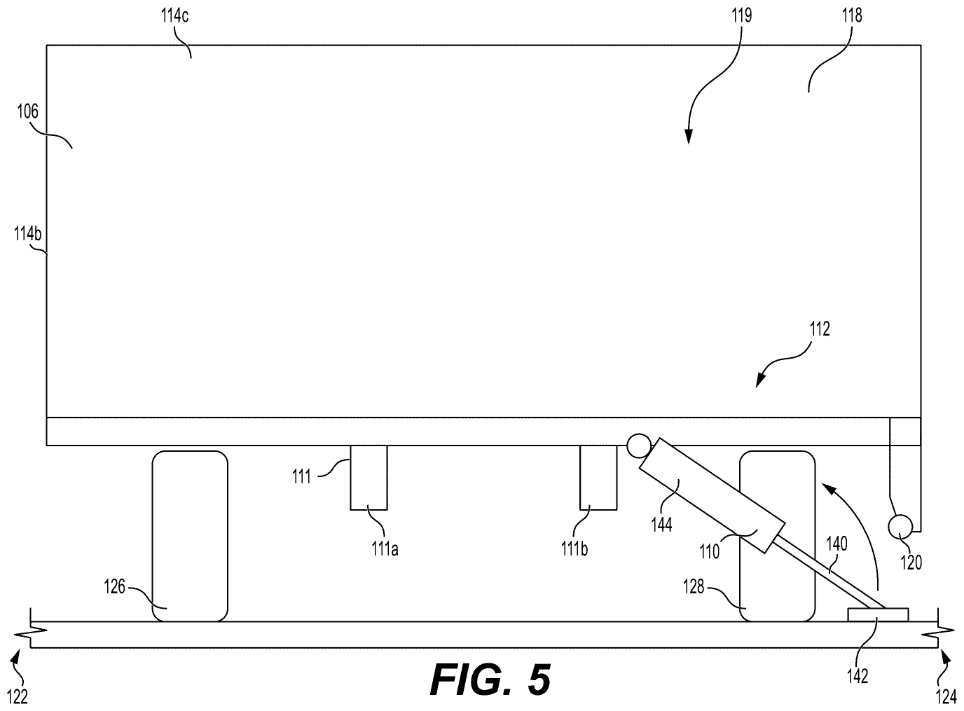

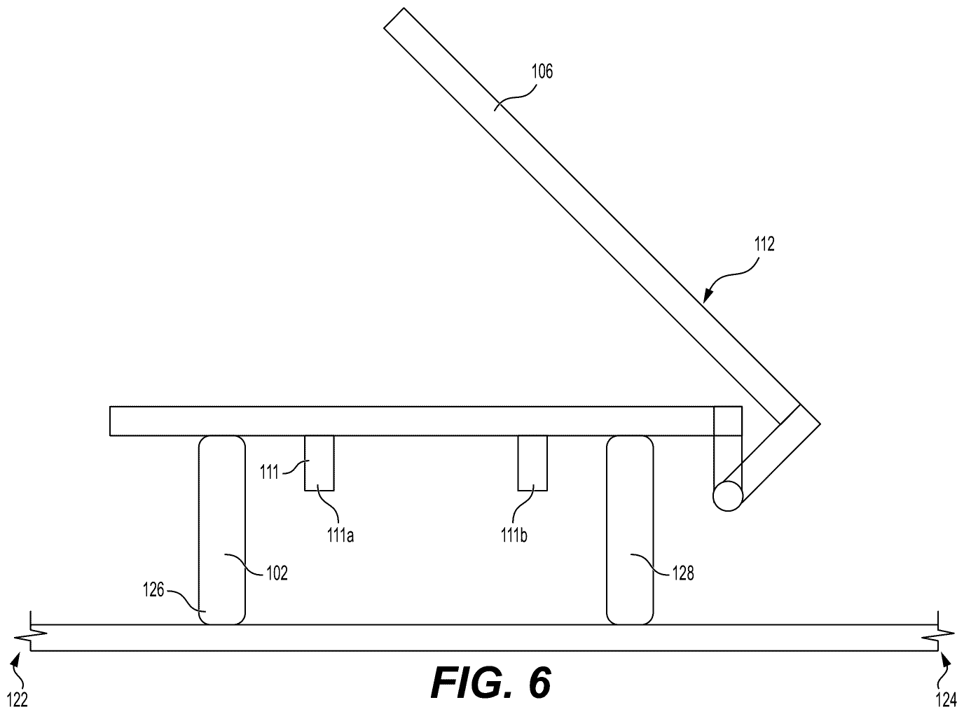

Preferably, the dump box 118 is pivotally attached to the wheeled chassis at a pivot joint 120 spaced below the dump box floor 112 (see FIGS. 5 and 6). The vehicle 100 preferably includes a hydraulic cylinder (not shown) to swing the dump box between a lowered condition (see FIGS. 1 and 2) and a raised condition (see FIGS. 3 and 4).

In the lowered condition, side-dump bed 106 may extend laterally from a left side 122 of the wheeled chassis 102 to a right side 124 of the wheeled chassis 102 (see FIG. 5). The right side 124 may correspond with a dump side of the wheeled chassis 102. In the raised condition, side-dump bed may be pivoted upwardly and laterally from the lowered condition toward the right side 124 (see FIG. 6). Wheeled chassis 102 may further include left side wheels 126 and right side wheels 128 (see FIGS. 5 and 6).

The pivot joint 120 of dump box 118 may be preferably located along the right side of the dump box 118 (see FIG. 6) to facilitate dumping of landscaping materials along the right side 124 (that is, the dump side) of the wheeled chassis 102. More preferably, the pivot joint 120 may be positioned outboard of the vehicle's right side wheels 128 (see FIG. 6). However, alternative embodiments may have the pivot joint alternatively located. For instance, an alternative vehicle may have the pivot joint positioned along the left side of the dump box so that landscaping materials may be dumped along the left side 122 of the wheeled chassis 102.

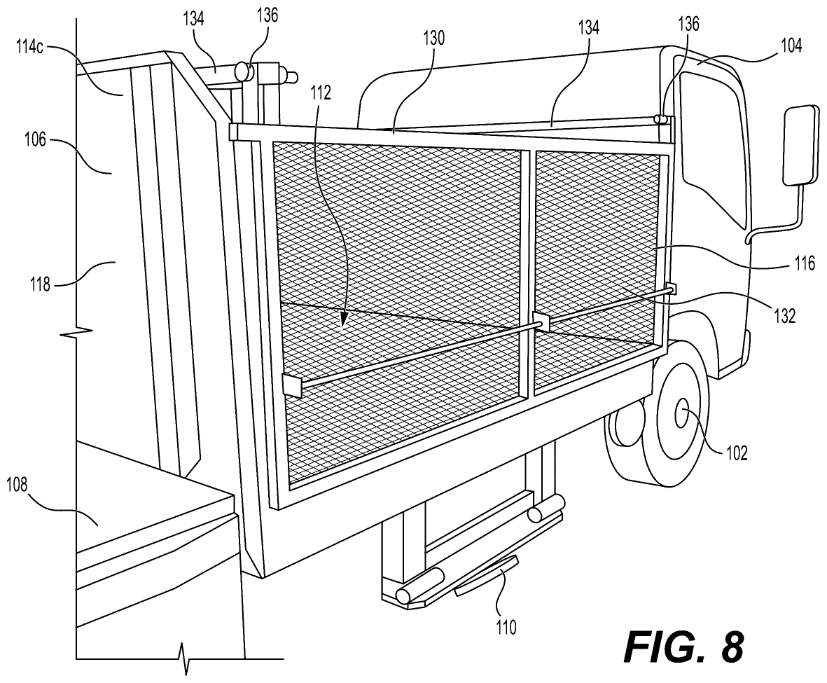

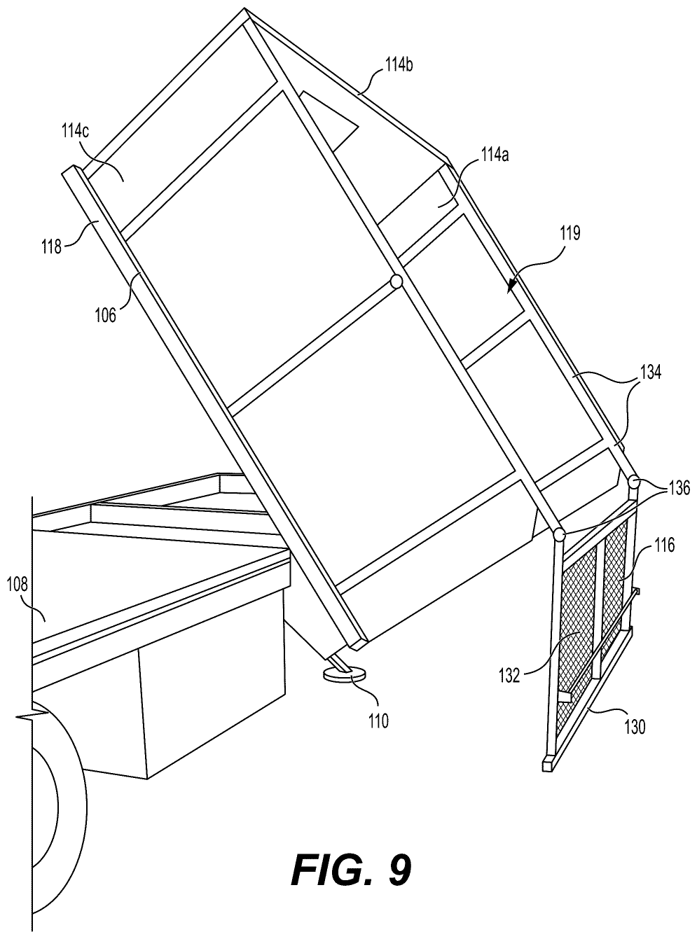

Turning to FIGS. 8 and 9, the depicted outboard door 116 may include a door frame 130 and a door panel 132 fixed to the door frame 130. In the depicted embodiment, door panel 132 may comprise a perforated metal sheet. In other embodiments, the door panel may include an alternative sheet structure (such as a solid metal sheet). Outboard door 116 may be swingably attached to brackets 134 associated with corresponding side walls 114a and 114c. In particular, outboard door 116 may be pivotally attached to brackets 134 at pivot joints 136.

Outboard door 116 of dump box 118 may be selectively opened and closed for various purposes. For instance, the outboard door 116 may be closed so that dump box 118 is configured to contain materials. Outboard door 116 may also be opened to permit discharge of materials from the dump box 118.

Again, the outboard door 116 of dump box 118 may be swingably mounted to respective side walls 114a and 114c to shift into and out of the closed position (see FIGS. 2, 3, and 8), in which the outboard door restricts materials from falling out of the dump box 118. Outboard door 116 may also be swingably mounted to shift into and out of an open position (see FIG. 9), in which the outboard door 116 may permit materials to be discharged out of the chamber 119 of the dump box 118. For instance, with the dump box 118 in the raised position, the outboard door 116 permits materials to fall out of the dump box 118 due to gravity. It will also be appreciated that the outboard door 116 may be opened when the dump box 118 is lowered to permit removal of materials.

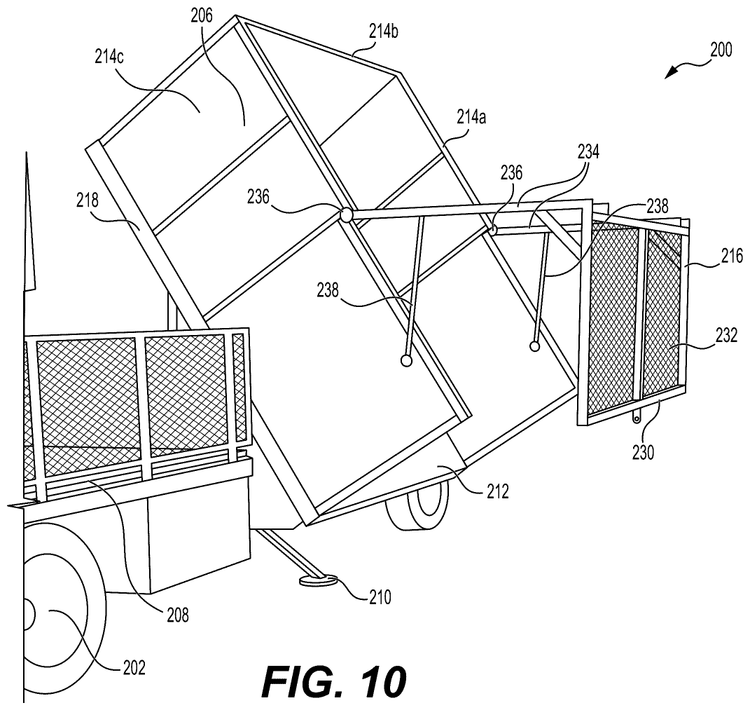

In other dump box embodiments, the outboard door may be alternatively shiftably supported relative to the side walls 114a and 114c for movement between open and closed positions. In an alternative embodiment, a vehicle 200 may include a wheeled chassis 202, a side-dump bed 206, a rear-dump bed 208, and an outrigger 210. The alternative side-dump bed 206 may preferably include a floor 212, side walls 214a, 214b, 214c, and an alternative outboard door 216 that cooperatively form a dump box 218 (see FIG. 10). The outboard door 216 may include a door frame 230, a door panel 232, and door arms 234. Door arms 234 may have outboard portions fixed to the door frame 230 and inboard portions swingably attached to corresponding side walls 214a and 214c at pivot joints 236. Dump box 118 may further include lift assist springs 238 associated with respective door arms 234. The lift assist springs 238 may be operable to facilitate up and down swinging of the outboard door 216.

As with outboard door 116, the outboard door 216 may be swingably mounted to respective side walls 214a and 214c to shift between the closed position (not shown) and the open position (see FIG. 10). When opened, the outboard door 216 may permit materials (such as waste material) to be discharged out of the dump box 218.

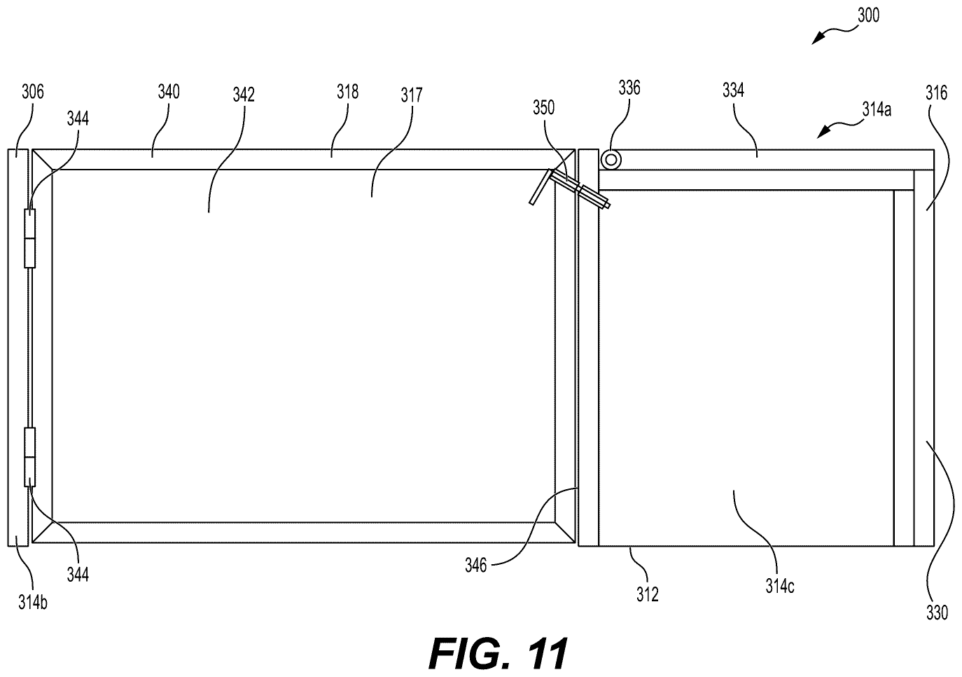

Turning to FIG. 11, in another alternative embodiment, a vehicle 300 may include an alternative side-dump bed 306. The side-dump bed 306 may include a floor 312, side walls 314a,314b,314c, an outboard door 316 (similar to outboard door 216), and a rear door 317 that cooperatively form a dump box 318. The outboard door 316 may include a door frame 330, a door panel (not shown), and door arms 334. Door arms 334 may have outboard portions fixed to the door frame 330 and inboard portions swingably attached to corresponding side walls 314a and 314c at pivot joints 336.

The rear door 317 may comprise a solid door structure having a frame 340 and a solid door panel 342 fixed to the frame 340. Rear door 317 may be pivotally attached to the left side wall 314b via upper and lower hinges 344. Rear door 317 may be swung into and out of a closed position in which the rear door 317 extends laterally between respective side walls 314b and 314c. When closed, the rear door 317 spans an access opening 346 defined between the side walls 314b and 314c. Dump box 318 also preferably includes a latch 350 to removably secure the rear door 317 in the closed position.

The rear door 317 may be selectively opened by swinging the rear door 317 forwardly out of the closed position. When rear door 317 is open, the access opening 346 may permit ingress and egress of people, equipment, and/or materials relative to the chamber of the dump box 318. Furthermore, when side-dump bed 306 and rear-dump bed (not shown) are both lowered, rear door 317 may be opened to permit transfer of people, equipment, and/or materials between the floor 312 of the side-dump bed 306 and the floor of the rear-dump bed. For example, it will be appreciated that wheeled equipment (such as a mower) may be rolled between the side-dump bed 306 and the rear-dump bed when the rear door 317 is open.

Turning to FIG. 5, the outrigger 110 may be preferably configured to stabilize the vehicle 100 when the side-dump bed 106 is raised to discharge materials (such as waste material) contained within the dump box 118. Outrigger 110 may preferably include an arm 140 shiftably mounted relative to the chassis 102 and a lowermost foot 142 operable to removably engage the ground in an extended position (see FIG. 5). The preferred outrigger 110 may also include a hydraulic cylinder 144 operably attached to the arm 140 for driving the arm 140 between a retracted position, in which the foot 142 is spaced above the ground, and a deployed position, in which the foot 142 is positioned in engagement with the ground.

When the outrigger 110 is deployed, the foot is preferably located outboard of the vehicle's right side wheels 128 and is located adjacent the pivot joint 120 of the dump box 118. In use, the outrigger 110 is preferably deployed and engaged with the ground prior to raising the dump box 118 (and materials contained therein) out of the lowered condition. Once the dump box 118 has been emptied and returned to the lowered condition, the outrigger 110 may be returned to the retracted position in which the outrigger 110 is spaced above the ground. It will also be understood that the outrigger may be retracted after emptying of the dump box 118 but prior to returning the dump box 118 to the lowered condition.

It is within the scope of the present invention for the outrigger to have an alternative configuration. For instance, embodiments of the outrigger may include multiple arms and/or fect spaced along the vehicle axis (e.g., to provide enhanced stabilizing engagement with the ground). An alternative outrigger may also be alternatively positioned. For instance, where the dump bed is configured to dump toward the left side of the vehicle, it will be appreciated that the outrigger may be positioned along the left side of the vehicle. It is also within the scope of at least certain aspects of the present invention for an alternative vehicle to be devoid of an outrigger.

Turning to FIGS. 2-4 and 7, the illustrated rear flat bed 108 is supported by the chassis 102 rearwardly of the dump bed 106. In preferred embodiments, the rear flat bed 108 is configured to removably receive and support one or more items of equipment, such as landscaping equipment (e.g., tractors, mowers, fertilizers, aerators, seeders, rakes, trailers, etc.). It is also within the scope of the present invention for the rear flat bed 108 to be used for holding and transporting landscaping materials (such as grass clippings, leaves, branches, etc.), other materials, tools, and/or other equipment.

Rear-dump bed 108 preferably includes a floor 150, opposite side walls 152, and a rear gate 154. The floor 150 is preferably incorporated as part of a flat bed construction. The depicted rear-dump bed 108 is pivotally attached to the chassis 102 at a pivot joint 156 spaced below the floor 150 (see FIG. 7). The vehicle 100 preferably includes a pair of hydraulic cylinders (not shown) to swing the rear-dump bed 108 between a lowered position (see FIGS. 1 and 2) and a raised position (see FIGS. 3 and 4). In the raised position, a forward margin of the floor 150 preferably defines a raised floor dimension B measured relative to the lowered position (see FIG. 7).

The pivot joint 156 of rear-dump bed 108 is preferably positioned rearwardly of the rear axle 158 (see FIG. 7). Additionally, the preferred pivot joint 156 of the rear-dump bed 108 is spaced below the floor 150 of the rear-dump bed 108. However, alternative embodiments of the rear-dump bed may have the pivot joint alternatively located relative to the wheeled chassis and/or other elements of the rear-dump bed without departing from the scope of certain aspects of the present invention.

In the usual manner, the rear gate 154 may be selectively shifted between a closed position, in which the rear-dump bed 108 may contain equipment and/or materials, and an open position, in which the rear gate 154 permits loading and unloading of equipment and/or materials relative to the floor 150. It will be appreciated that rear-dump bed 108 may be raised or lowered while the rear gate 154 is in either the closed position or the open position. Preferably, the rear-dump bed 108 is raised and the rear gate 154 is open when equipment is loaded or unloaded relative to the floor 150 of the rear-dump bed 108.

Rear-dump bed 108 may at least partly overlap the side-dump bed 106 in a direction transverse to the vehicle axis V. More preferably, rear-dump bed 108 and side-dump bed 106 may be generally coextensive with one another along the transverse direction. The illustrated combination of the dump box 118 and the rear-dump bed 108 facilitates convenient dumping of materials into the dump box 118. In particular, with the dump box 118 in the lowered condition and the rear-dump bed 108 in the raised position (see FIG. 7), a mower (not shown) may be positioned adjacent the forward margin of the floor 150 to readily dump materials over a rear lip of the dump box 118 and into the dump box 118.

In the raised position, the raised floor dimension B is preferably at least half the dump box height dimension A. Preferably, the raised floor dimension B ranges from about twelve inches (12″) to about forty-eight inches (48″) and, more preferably, ranges from about eighteen inches (18″) to about twenty-four inches (24″).

Also in the raised position, the forward margin of the floor 150 is preferably spaced adjacent the rear side wall of the dump box 118 to define a spacing dimension C. Preferably, the spacing dimension C ranges from about four inches (4″) to about twelve inches (12″).

While the illustrated flat bed and dump bed are preferably mounted on a common chassis, it is within the scope of at least certain aspects of the present invention for alternative embodiments of the flat bed and dump bed to be mounted on respective chassis that are removably attached to one another. In one example of such an alternative embodiment, the flat bed may be incorporated as part of a trailer that is towed by a truck that supports the dump bed.

Although the depicted arrangement of the side-dump bed 106 and the rear-dump bed 108, relative to the forward direction of the vehicle, is preferred, it will be appreciated that the beds may be alternatively positioned relative to vehicle axis and/or relative to one another. For example, alternative embodiments may have at least portions of the dump bed and the flat bed arranged alongside one another (such that the beds overlap one another along the vehicle axis).

Various other aspects and advantages of the present invention will be apparent from the following detailed description of the preferred embodiments and the accompanying drawing figures. While the drawings illustrate, and the specification describes, certain preferred embodiments of the invention, it is to be understood that such disclosure is by way of example only. There is no intent to limit the principles of the present invention to the particular disclosed embodiments. In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

It will be appreciated that the various embodiments described herein are not necessarily mutually exclusive unless otherwise indicated herein. For example, a feature described or depicted in one embodiment may also be included in other embodiments, but is not necessarily included. Thus, the present invention encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description may also use numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

In one or more embodiments, the side-dump bed, rear-dump bed, outrigger 110, and other components of the vehicles described above may be preferably formed of a metal material, such as steel or carbon steel. However, it is within the scope of the present invention for one or more components to include an alternative metal (such as stainless steel, aluminum, etc.), alloys thereof, or a non-metal material (such as a synthetic resin).

Additional advantages of the various embodiments of the invention will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments, but is not necessarily included. Thus, the present invention encompasses a variety of combinations and/or integrations of the specific embodiments described herein. As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

Although the above description presents features of exemplary embodiments of the present invention, other preferred embodiments may also be created in keeping with the principles of the invention. Such other preferred embodiments may, for instance, be provided with features drawn from one or more of the embodiments described above. Yet further, such other preferred embodiments may include features from multiple embodiments described above, particularly where such features are compatible for use together despite having been presented independently as part of separate embodiments in the above description. The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

1. A utility vehicle configured to be advanced forwardly during transport, said utility vehicle comprising:
a wheeled chassis including a chassis frame extending along a fore-and-aft vehicle axis; and
a side-dump bed configured to contain and selectively discharge material toward a dump side of the wheeled chassis,
said side-dump bed being shiftably attached to the chassis frame for movement between a lowered condition, in which the side-dump bed extends laterally from the dump side of the wheeled chassis to an opposite side thereof, and a raised condition, in which the side-dump bed is shifted toward the dump side to discharge material.

2. The utility vehicle as claimed in claim 1, further comprising:
an outrigger attached relative to the chassis frame and configured to removably engage a ground location adjacent the dump side of the wheeled chassis.

3. The utility vehicle as claimed in claim 2,
said outrigger including a foot shiftable into and out of an extended position in which the foot is located outboard of the dump side of the wheeled chassis.

4. The utility vehicle as claimed in claim 3,
said outrigger including a motor operably attached to the foot and operable to shift the foot into and out of the extended position.

5. The utility vehicle as claimed in claim 3,
said side-dump bed including an outboard margin located outboard of the dump side of the wheeled chassis,
said foot being located inboard of the outboard margin when in the extended position.

6. The utility vehicle as claimed in claim 3,
said side-dump bed being pivotally attached to the chassis frame at a pivot joint, with the side-dump bed being pivotal about a pivot axis defined by the pivot joint between the lowered condition and the raised condition.

7. The utility vehicle as claimed in claim 6,
said pivot axis being located outboard of the dump side of the wheeled chassis and at least partly outboard of the foot.

8. The utility vehicle as claimed in claim 2,
said side-dump bed including a dump box with side walls and a door that cooperatively define a chamber of the dump box,
said door being located outboard of the dump side of the wheeled chassis.

9. The utility vehicle as claimed in claim 8,
said outrigger including a foot shiftable into and out of an extended position in which the foot is located outboard of the dump side of the wheeled chassis and at least partly inboard of the door.

10. The utility vehicle as claimed in claim 1,
said side-dump bed being pivotally attached to the chassis frame at a pivot joint, with the side-dump bed being pivotal about a pivot axis defined by the pivot joint between the lowered condition and the raised condition.

11. The utility vehicle as claimed in claim 10,
said pivot axis being located outboard of the dump side of the wheeled chassis.

12. A utility vehicle configured to be advanced forwardly during transport, said utility vehicle comprising:
a wheeled chassis including a chassis frame extending along a fore-and-aft vehicle axis; and
a forward bed and an aft bed each supported by the wheeled chassis, with the aft bed located rearwardly of the forward bed,
at least one of the forward bed and the aft bed comprising a side-dump bed configured to contain and selectively discharge material toward a dump side of the wheeled chassis,
said side-dump bed being shiftably attached to the chassis frame for movement between a lowered condition, in which the side-dump bed extends laterally from the dump side of the wheeled chassis to an opposite side thereof, and a raised condition, in which the side-dump bed is shifted toward the dump side to discharge material.

13. The utility vehicle as claimed in claim 12,
said forward bed comprising the side-dump bed, with the aft bed being shiftably attached to the chassis frame to provide a rear-dump bed.

14. The utility vehicle as claimed in claim 13,
said rear-dump bed being pivotally attached to the chassis frame at a pivot joint, with the rear-dump bed being pivotal about a pivot axis defined by the pivot joint.

15. The utility vehicle as claimed in claim 13,
said rear-dump bed at least partly overlapping the side-dump bed in a direction transverse to the vehicle axis.

16. The utility vehicle as claimed in claim 12, further comprising:
an outrigger attached relative to the chassis frame and configured to removably engage a ground location adjacent the dump side of the wheeled chassis.

17. The utility vehicle as claimed in claim 16,
said side-dump bed including a dump box with side walls and a door that cooperatively define a chamber of the dump box,
said door being located outboard of the dump side of the wheeled chassis.

18. The utility vehicle as claimed in claim 17,
said outrigger including a foot shiftable into and out of an extended position in which the foot is located outboard of the dump side of the wheeled chassis and at least partly inboard of the door.

19. The utility vehicle as claimed in claim 12,
said side-dump bed being pivotally attached to the chassis frame at a pivot joint, with the side-dump bed being pivotal about a pivot axis defined by the pivot joint between the lowered condition and the raised condition.

20. The utility vehicle as claimed in claim 19,
said pivot axis being located outboard of the dump side of the wheeled chassis.
